(19) United States
(12) Patent Application Publication
(10) Pub. No.: US 2006/0018004 A1
(43) Pub. Date: Jan. 26, 2006

(54) Photoreaction apparatus

(75) Inventors: Teruo Okano, Ichikawa-shi (JP); Kazuyoshi Itoga, Moriguchi-shi (JP); Shouichi Yoshii, Fujiidera-shi (JP); Takashi Miwa, Higashiosaka-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANYO ELECTRIC CO., LTD., Moriguchi-shi (JP); SANYO ELECTRIC BIOMEDICAL CO., LTD., Moriguchi-shi (JP)

(21) Appl. No.: 11/181,022

(22) Filed: Jul. 14, 2005

(30) Foreign Application Priority Data
Jul. 23, 2004 (JP) 215552/2004

(51) Int. Cl. G02B 26/00

(52) U.S. Cl. 359/291

(57) ABSTRACT

An object of the present invention is to provide a photoreaction apparatus which can inexpensively and quickly prepare a micropattern. The photoreaction apparatus comprises an LCD projector which irradiates an LCD panel for displaying an input image with light to thereby project the image; a sample laying stage on which a photoreactive sample is laid; a reducing projection lens which reduces the projected light from the LCD projector to form an image on the sample; and a zoom adjustment mechanism for adjusting a projective magnification of the image to be formed on the sample. The zoom adjustment mechanism comprises a first adjustment section for adjusting a distance between the LCD panel and the reducing projection lens; and a second adjustment section for adjusting a distance between the reducing projection lens and the sample.

### TECHNICAL FIELD

The present invention relates to a photoreaction apparatus for micro patterning of cells, or preparing of a micro channel or the like (hereinafter referred to generically as the micropattern) by photopolymerization of a monomer or an olygomer, or exposure of a photoresist.

### BACKGROUND ART

In recent years, micro patterning of cells has been used in basic researches on transmission of signals between the cells, or preparation of biosensors utilizing cells. Moreover, by utilizing a combination of a plurality of micropatterns of the cells, the application of the technique to tissue engineering is also expected.

As such a technique of the micro patterning of the cells, photolithography has heretofore been utilized which is a semiconductor manufacturing techniques (see, e.g., Japanese Patent Application Publication No. 2002-510969). In this photolithography, for example, light such as ultraviolet light is reduced by a lens, and projected onto a silicon wafer to bake a circuit pattern via a photomask in which a pattern of chromium is drawn on a glass plate.

Moreover, in the micro patterning of the cell, a substrate is coated with a thin photoreactive sample, and the light is reduced and projected on the sample to polymerize the sample via the photomask in which the micropattern is drawn.

However, in this conventional method, since an expensive exclusive-use apparatus is required, and the photomask of a metal or glass is further required in preparing the pattern, there has been a problem that very much time and cost are required in manufacturing the photomask.

The present invention has been developed to solve the conventional technical problem, and an object thereof is to provide a photoreaction apparatus which can inexpensively and quickly prepare such micropattern.

### SUMMARY OF THE INVENTION

According to a first invention of the present application, there is provided a photoreaction apparatus comprising: an LCD projector which irradiates an LCD panel for displaying an input image with light to thereby project the image; a sample laying stage on which a photoreactive sample is laid; a reducing projection lens which reduces the projected light from the LCD projector to form an image on the sample; and a zoom adjustment mechanism for adjusting a projective magnification of the image to be formed on the sample.

According to a photoreaction apparatus of a second invention of the present application, in the above-described invention, the zoom adjustment mechanism is constituted of a first adjustment section for adjusting a distance between the LCD panel and the reducing projection lens, and a second adjustment section for adjusting a distance between the reducing projection lens and the sample.

According to a photoreaction apparatus of a third invention of the present application, in the above-described inventions, the apparatus further comprises a blackout curtain for blocking the introduction of incident light from the outside into a projection path extending from the LCD projector to the sample.

According to a photoreaction apparatus of a fourth invention of the present application, in the above-described inventions, the apparatus further comprises a scope for confirming focus of the image to be formed on the sample.

According to a photoreaction apparatus of a fifth invention of the present application, in the above-described inventions, the apparatus further comprises a moving mechanism for moving the sample in synchronization with a dynamic image input into the LCD projector.

According to the first invention of the present application, there is provided the photoreaction apparatus comprising: the LCD projector which irradiates the LCD panel for displaying the input image with light to thereby project the image; the sample laying stage on which the photoreactive sample is laid; the reducing projection lens adjustment and focus adjustment of the image to be formed on the sample can be smoothly and securely performed.

Moreover, as in the third invention of the present application, there is disposed the blackout curtain for interrupting entrance of the incident light from the outside into the projection path extending from the LCD projector to the sample. Consequently, it is possible to eliminate an adverse influence by the incident light from the outside while securing operability. Furthermore, when there is disposed the scope for confirming the focus of the image to be formed on the sample as in the fourth invention, the focus of the image to be formed on the sample can be easily confirmed.

Furthermore, there is disposed the moving mechanism for moving the sample in synchronization with the dynamic image input into the LCD projector as in the fifth invention. For example, to handle the image whose dimension is larger than that of the LCD panel, the image is prepared as a horizontally or vertically moving image (dynamic image) in a personal computer, and the image (dynamic image) is displayed in the LCD panel. Moreover, the sample is moved in synchronization with the movement of the image (dynamic image). Consequently, it is possible to prepare the micro shape having a large whole dimension.

### BRIEF DESCRIPTION OF THE DRAWINGS

FIG. 1 is a front perspective view of a which reduces the projected light from the LCD projector to form the image on the sample; and the zoom adjustment mechanism for adjusting the projective magnification of the image to be formed on the sample. Therefore, for example, when image data prepared by a personal computer or the like is input into the LCD projector, the image is reduced and formed on the sample, so that a fine shape can be prepared by photoreaction.

Consequently, it is possible to project the image directly on the sample and prepare a micropattern or the like without using any photomask as in the conventional technique, so that a preparing operation can be speeded up, and costs can be reduced. Especially, since the apparatus can be constituted utilizing the general-purpose LCD projector, production costs of the apparatus itself can be remarkably reduced.

Especially since the projective magnification of the image to be formed on the sample can be adjusted by the zoom adjustment mechanism, a dimension of the micro shape can be adjusted in accordance with application, and the apparatus becomes superior in general purposes. Especially, in this case, as in the second invention, the zoom adjustment mechanism comprises: the first adjustment section for adjusting the distance between the LCD panel and the reducing projection lens; and the second adjustment section for adjusting the distance between the reducing projection lens and the sample. Consequently, zoom photoreaction apparatus according to an embodiment of the present invention;

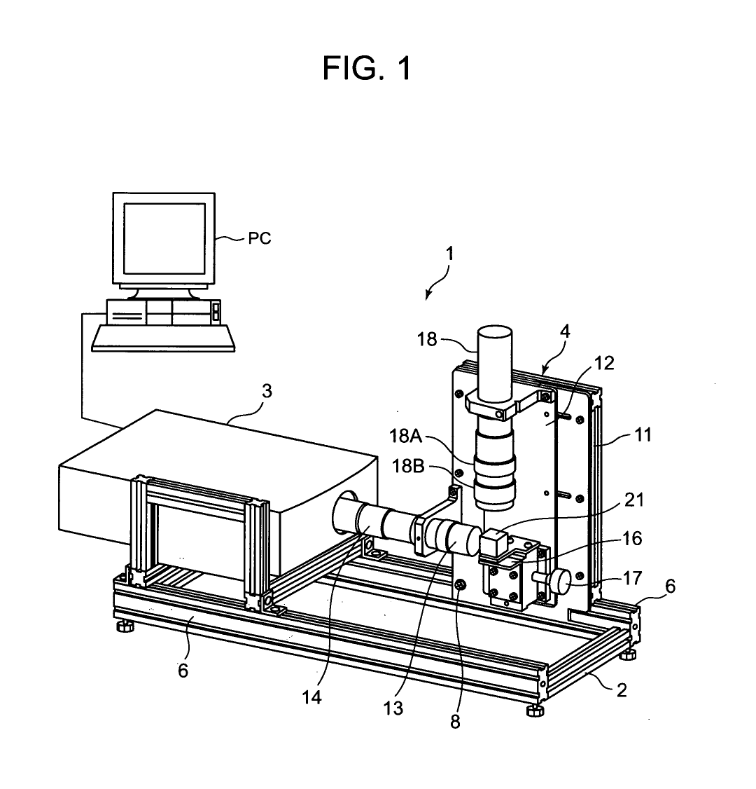

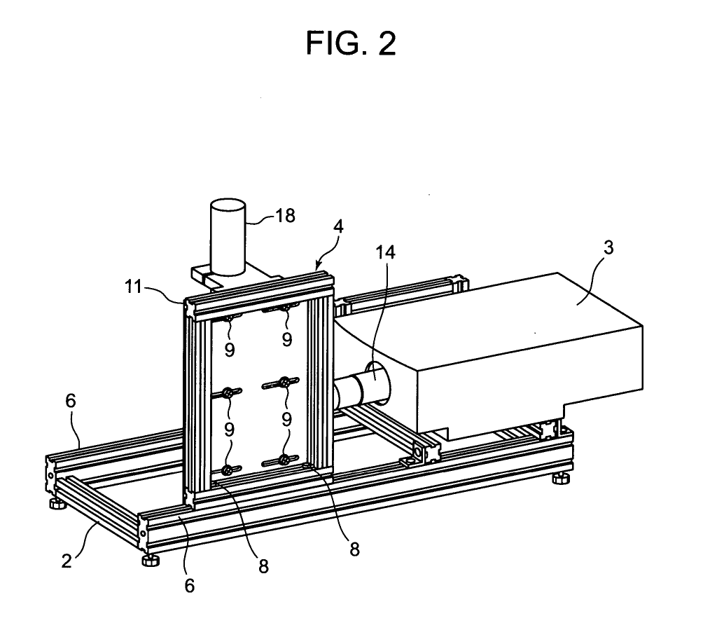

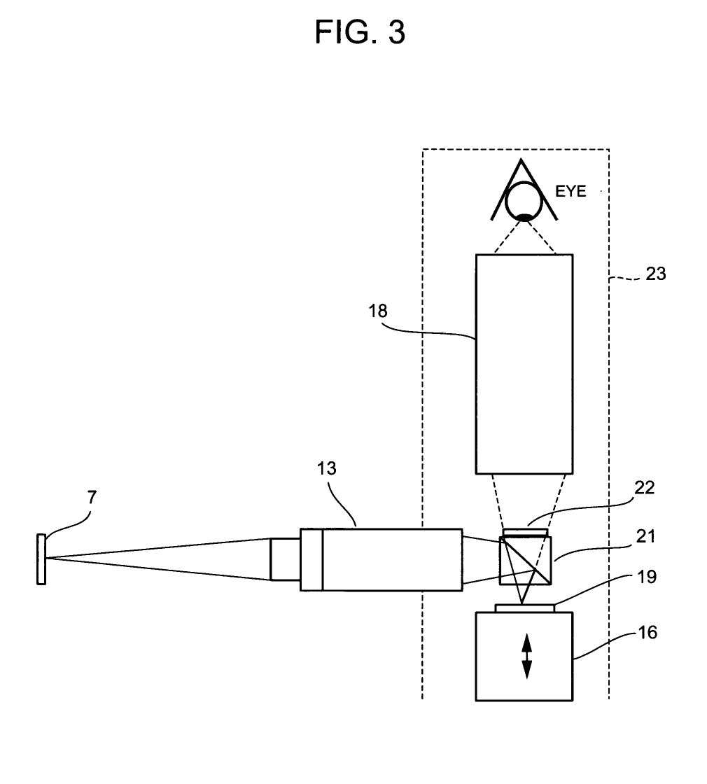

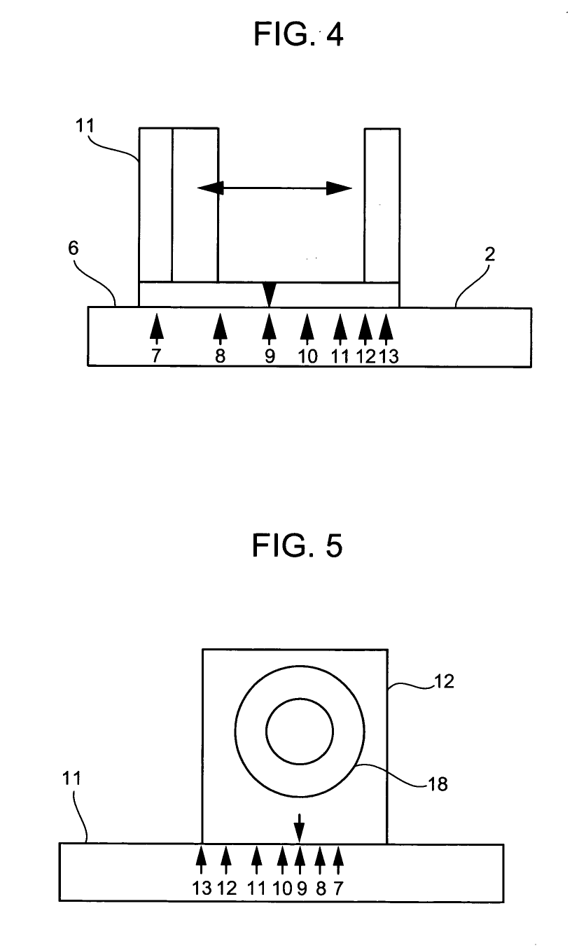

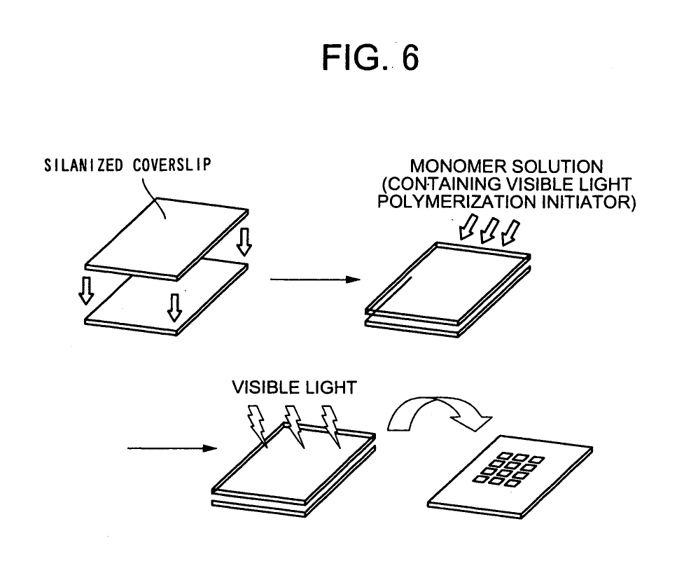

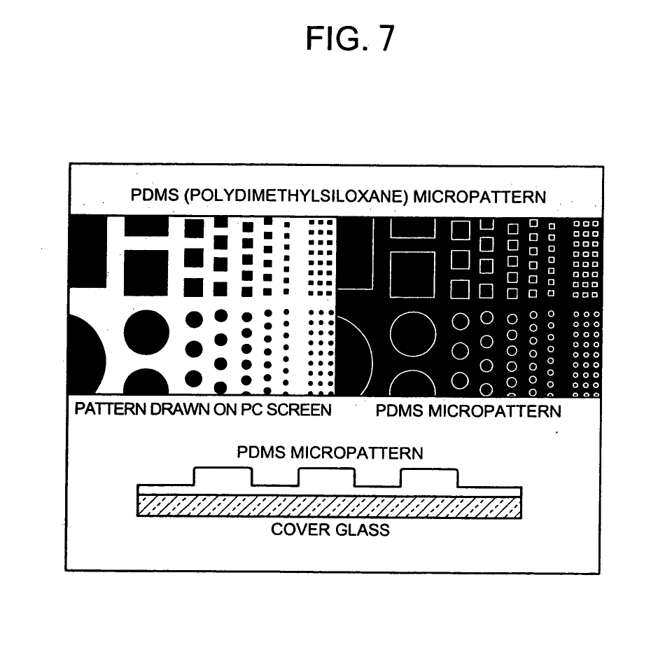

FIG. 2 is a rear perspective view of the photoreaction apparatus shown in FIG. 1;

FIG. 3 is a diagram showing a projection path of the photoreaction apparatus shown in FIG. 1;

FIG. 4 is a back view showing a frame housing and a first adjustment base of the photoreaction apparatus shown in FIG. 1;

FIG. 5 is a plan view showing the first adjustment base and a second adjustment base of the photoreaction apparatus shown in FIG. 1;

FIG. 6 is a diagram showing a structure of a sample and irradiation of the sample with light; and

FIG. 7 is a diagram showing a micropattern of polydimethylsiloxane prepared by the photoreaction apparatus of FIG. 1.

### DETAILED DESCRIPTION OF THE EMBODIMENTS

Next, an embodiment of the present invention will be described in detail with reference to the drawings. FIG. 1 is a front perspective view of a photoreaction apparatus 1 according to one embodiment of the present invention, and FIG. 2 is a rear perspective view of the photoreaction apparatus 1. The photoreaction apparatus 1 of the embodiment comprises: a frame housing 2; a liquid crystal display (LCD) projector 3, a zoom adjustment mechanism 4 and the like mounted on the frame housing 2; a personal computer PC and the like.

Attachment rails 6, 6 each extending horizontally are disposed in front and rear portions of the frame housing 2, and the LCD projector 3 is fixed via the attachment rails 6, 6 on the left side (as one faces the figure) of the frame housing 2. This LCD projector 3 is a general-purpose LCD projector provided with an liquid crystal display (LCD) panel 7 shown in FIG. 3, and a lamp (not shown). The projector is connected to the personal computer PC in such a manner that image data is input from the personal computer PC. In this case, the LCD panel 7 is an LCD panel having a high definition of 14 to 36 μm/pixel (18 μm/pixel in the embodiment). Moreover, the LCD projector 3 displays the input image from the personal computer PC in the LCD panel 7, and irradiates the LCD panel 7 with light from the lamp to thereby project the input image toward the right (as one faces the figure) of the frame housing 2.

The zoom adjustment mechanism 4 comprises: a first adjustment base (first adjustment section) 11 horizontally (i.e., in a longitudinal direction of the attachment rails 6, 6) movably attached to the rear-side attachment rail 6 of the frame housing 2 by bolts 8, 8 (hexagonal bolts in the embodiment) on the right side (as one faces the figure); and a second adjustment base (second adjustment section) 12 horizontally (i.e., in the longitudinal direction of the attachment rails 6, 6) movably attached to the first adjustment base 11 by bolts 9 . . . (hexagonal bolts in the embodiment).

Moreover, a reducing projection lens (a 0.5-time image forming lens in the embodiment) 13 is attached to a position facing the LCD panel 7 of the LCD projector 3 in a left end portion (as one faces the figure) of the first adjustment base 11. Moreover, the LCD projector 3 is provided with an extendable barrel 14 which extends from the LCD panel 7 to the reducing projection lens 13, so that projected light from the LCD projector 3 reaches the reducing projection lens 13 via the extendable barrel 14.

Moreover, a sample laying stage 16 is attached to a lower portion of the second adjustment base 12. When a stage elevating knob 17 is turned, the sample laying stage 16 can be elevated/lowered with respect to the second adjustment base 12. A scope 18 for confirming focus is attached to an upper portion of the second adjustment base 12, and positioned above the sample laying stage 16. When looking into the scope 18 from above, an operator confirms the focus of an image to be formed on a sample 19 (FIG. 3) laid on the sample laying stage 16 disposed below. The scope comprises a delivery adjustment ring 18A and a focus adjustment ring 18B.

A beam splitter 21 is attached to a portion of the second adjustment base 12 between the sample laying stage 16 and the scope 18, and disposed in a position facing the reducing projection lens 13 in a horizontal direction. This beam splitter 21 splits the projected light passed through the reducing projection lens 13 into light on a front side and a lower sample laying stage 16 side. An ND filter 22 is disposed on the beam splitter.

Although not shown in FIGS. 1 and 2, the sample laying stage 16, the beam splitter 21, the scope 18, and a portion of the reducing projection lens 13 on a beam splitter 21 side are covered with a blackout curtain 23 as shown by a broken line of FIG. 3. The blackout curtain 23 prevents incidence of light from the outside into a path of the projected light from the LCD projector 3 to the sample 19. The blackout curtain can be easily opened and closed in a case where the sample 19 or the like is mounted on the sample laying stage 16.

It is to be noted that since the extendable barrel 14 is disposed between the LCD projector 3 and the reducing projection lens 13 in the present embodiment, the incident light of the outside is interrupted. However, when the extendable barrel 14 is not disposed, a portion of the LCD projector 3 on a reducing projection lens 13 side is also covered with the blackout curtain 23.

Next, a method will be described in which a micropattern is prepared using the photoreaction apparatus 1 constituted as described above according to the present invention. It is to be noted that the blackout curtain 23 is assumed to be removed in the beginning. First, a projective magnification with respect to the sample 19 is adjusted using the zoom adjustment mechanism 4. In the present embodiment, the projective magnification can be adjusted as a projected pixel size in a range of 7 to 13 μm/pixel. Now assuming that the projected pixel size (projective magnification) is adjusted into 9 μm/pixel, first the bolts 8, 8 of the first adjustment base 11 are loosened to move the first adjustment base 11 in the horizontal direction, and an arrow described on the first adjustment base 11 is aligned with numeral 9 described on the frame housing 2. It is to be noted that, as shown in FIG. 4, numerals 7 to 13 (the projected pixel sizes) are described on the frame housing 2.

Here, a distance is measured beforehand between the LCD panel 7 and the reducing projection lens 13, the distance being suitable for the projected pixel size. When the arrow of the first adjustment base 11 is aligned with the numeral of the frame housing 2, the distance between the LCD panel 7 and the reducing projection lens 13 is adapted to the projected pixel size indicated by the numeral. Moreover, the bolts 8, 8 are again tightened to fix the position of the first adjustment base 11.

Next, the bolts 9 . . . of the second adjustment base 12 are loosened to move the second adjustment base 12 in the horizontal direction, and an arrow described on the second adjustment base 12 is aligned with numeral 9 described on the first adjustment base 11. It is to be noted that, as shown in FIG. 5, numerals 7 to 13 (the projected pixel sizes) are described on the first adjustment base 11.

Here, a distance is measured beforehand between the reducing projection lens 13 and the sample 19, the distance being suitable for the projected pixel size. When the arrow of the second adjustment base 12 is aligned with the numeral of the first adjustment base 11, the distance between the reducing projection lens 13 and the sample 19 is adapted to the projected pixel size indicated by the numeral. Moreover, the bolts 9 . . . are again tightened to fix the position of the second adjustment base 12.

Accordingly, an image is formed just in focus on the sample 19 at the projective magnification corresponding to the projected pixel size of 9 μm/pixel. In this focused state, it is possible to confirm the light reflected by the sample 19, passed through the beam splitter 21, and directed upwards, when the light enters the scope 18. In this case, first the sample laying stage 16 is moved to a reference position using the stage elevating knob 17, and locked in the position. Next, a reflecting mirror (not shown) for checking focus is disposed on the sample laying stage 16.

Next, a power supply of the LCD projector 3 is turned on, and data of a predetermined pattern image for adjustment is input from the personal computer PC. Since the LCD projector 3 displays the input pattern image for adjustment in the LCD panel 7, such pattern for adjustment is projected on the reflecting mirror at the projective magnification. Next, the operator looks into the scope 18 from above to confirm the focused state of the pattern image for adjustment. In this case, if the image is blurred, the image may be adjusted using the focus adjustment ring 18B in such a manner that the image can be clearly seen.

When ending the adjustments of the projective magnification (zoom) and the focus in this manner, the reflecting mirror is removed, and instead the sample 19 is mounted on the sample laying stage 16. In this case, a plate thickness difference between the reflecting mirror and the sample 19 is adjusted by the stage elevating knob 17, or a spacer having a thickness corresponding to the difference may be disposed on the sample laying stage 16 to adjust the difference. Thereafter, the blackout curtain 23 is attached to cover the sample laying stage 16, the beam splitter 21, the scope 18, and the portion of the reducing projection lens 13 on the beam splitter 21 side as described above. This prevents the incidence of the light from the outside into the projected light path extending from the LCD projector 3 to the sample 19.

Here, as shown in FIG. 16, the sample 19 of the present embodiment includes a monomer solution containing a visible light polymerization initiator held between silanized coverslip coated with a silane coupling agent, and untreated cover glass.

Next, for example, a cell micropattern image to be projected on the sample 19 is prepared by the personal computer PC, or an image prepared otherwise is read into the personal computer PC, and input into the LCD projector 3. Since the LCD projector 3 displays the input image in the LCD panel 7, the image reduced by the reducing projection lens 13 is projected on the sample 19 at the above-described projective magnification.

After irradiating the sample 19 with light in this manner to cause a crosslinking polymerization reaction of a monomer, the untreated cover glass is peeled, and then a micropattern of a polymer is formed on the surface of the silanized coverslip. FIG. 7 shows a case where a micropattern of polydimethylsiloxane is prepared. In this case, an image drawn by the personal computer PC is shown on an upper left side of FIG. 7, and an actually prepared micropattern is shown on the right side of the image. On a lower side, a section of the silanized coverslip is shown, and it is seen that a cross-linked three-dimensional structure is constituted.

As described above, in the present invention, it is possible to project the image directly on the sample 19 and prepare the micropattern without preparing any photomask as in a conventional example. Therefore, a preparing operation can be speeded up, and costs can be reduced. Especially, since the apparatus can be constituted utilizing the general-purpose LCD projector 3, production costs of the apparatus itself can be remarkably reduced. Especially, since the projective magnification of the image to be formed on the sample 19 can be adjusted by the zoom adjustment mechanism 4, a dimension of a micro shape can be adjusted in accordance with application, and the apparatus have a lot of general-purpose properties. In this case, the zoom adjustment mechanism 4 includes: the first adjustment base 11 for adjusting the distance between the LCD panel 7 and the reducing projection lens 13; and the second adjustment base 12 for adjusting the distance between the reducing projection lens 13 and the sample 19. Therefore, the zoom and the focus of the image to be formed on the sample 19 can be smoothly and securely adjusted.

Moreover, the blackout curtain 23 is disposed in such a manner as to interrupt the incident light from the outside into the projection path extending from the LCD projector 3 to the sample 19. Therefore, it is possible to eliminate an adverse influence on the sample by the incident light from the outside. Moreover, since the blackout curtain 23 can be easily opened/closed, for example, an operation to install•replace the sample 19 (reflecting mirror) or the like can be easily performed.

Moreover, the pattern of the cell is controlled using the micropattern prepared in this manner. It is to be noted that as the micropattern, in addition to the cell micropattern, a micro passage (micro channel) or the like can be prepared.

Here, to handle the image having a dimension larger than that capable of being displayed once in the LCD panel 7, for example, the image may be prepared as a dynamic image which moves from the right to the left. In this case, a moving mechanism (not shown) is disposed which moves the sample laying stage 16 from the right to the left. Moreover, when the sample 19 is moved in synchronization with the movement of the image by the moving mechanism, it is possible to prepare a micro shape having a whole dimension larger than the size of the LCD panel 7.

It is to be noted that in the present embodiment, the micropattern is prepared by the crosslinking polymerization by the visible light of the monomer, but the present invention is not limited to this embodiment, and the present invention is also effective even using a so-called photoresist which is formed into a thin film and irradiated with light to change a structure.

1. A photoreaction apparatus comprising:
an LCD projector which irradiates an LCD panel for displaying an input image with light to thereby project the image;
a sample laying stage on which a photoreactive sample is laid;
a reducing projection lens which reduces the projected light from the LCD projector to form an image on the sample; and
a zoom adjustment mechanism for adjusting a projective magnification of the image to be formed on the sample.

2. The photoreaction apparatus according to claim 1, wherein the zoom adjustment mechanism is constituted of a first adjustment section for adjusting a distance between the LCD panel and the reducing projection lens, and a second adjustment section for adjusting a distance between the reducing projection lens and the sample.

3. The photoreaction apparatus according to claim 1, further comprising a blackout curtain for blocking the introduction of incident light from the outside into a projection path extending from the LCD projector to the sample.

4. The photoreaction apparatus according to claim 1, further comprising a scope for confirming focus of the image to be formed on the sample.

5. The photoreaction apparatus according to claim 1, further comprising a moving mechanism for moving the sample in synchronization with a dynamic image input into the LCD projector.

6. The photoreaction apparatus according to claim 2, further comprising a blackout curtain for blocking the introduction of incident light from the outside into a projection path extending from the LCD projector to the sample.

7. The photoreaction apparatus according to claim 2, further comprising a scope for confirming focus of the image to be formed on the sample.

8. The photoreaction apparatus according to claim 3, further comprising a scope for confirming focus of the image to be formed on the sample.

9. The photoreaction apparatus according to claim 6, further comprising a scope for confirming focus of the image to be formed on the sample.

10. The photoreaction apparatus according to claim 2, further comprising a moving mechanism for moving the sample in synchronization with a dynamic image input into the LCD projector.

11. The photoreaction apparatus according to claim 3, further comprising a moving mechanism for moving the sample in synchronization with a dynamic image input into the LCD projector.

12. The photoreaction apparatus according to claim 6, further comprising a moving mechanism for moving the sample in synchronization with a dynamic image input into the LCD projector.

13. The photoreaction apparatus according to claim 4, further comprising a moving mechanism for moving the sample in synchronization with a dynamic image input into the LCD projector.

14. The photoreaction apparatus according to claim 7, further comprising a moving mechanism for moving the sample in synchronization with a dynamic image input into the LCD projector.

15. The photoreaction apparatus according to claim 8, further comprising a moving mechanism for moving the sample in synchronization with a dynamic image input into the LCD projector.

16. The photoreaction apparatus according to claim 9, further comprising a moving mechanism for moving the sample in synchronization with a dynamic image input into the LCD projector.
